(19) United States
(12) Patent Application Publication
(10) Pub. No.: US 2011/0131828 A1
(43) Pub. Date: Jun. 9, 2011

(54) Device for Hardening the Coating of an Object, Consisting of a Material that Hardens Under Electromagnetic Radiation, More Particularly an UV Paint or a Thermally Hardening Paint

(76) Inventor: Werner Swoboda, Boeblingen (DE)

(21) Appl. No.: 13/017,977

(22) Filed: Jan. 31, 2011

Related U.S. Application Data
(62) Division of application No. 10/565,746, filed on Aug. 28, 2006.

(30) Foreign Application Priority Data
Jul. 24, 2003 (DE) 103 35 004.7
May 13, 2004 (DE) 10 2004 023 538.4

(51) Int. Cl. F26B 3/30; F26B 3/34; F26B 3/347

(52) U.S. Cl. 34/267; 34/245; 34/276; 34/272

(57) ABSTRACT

A method for hardening a coating of an object, more particularly a car body. A conveyor system moves the object to the proximity of a radiator and moves it away from said radiator with at least one transport cart that can be translationally moved on at least one running surface. A support frame for the object is fixed to the transport cart in order to rotate or pivot the object about a rotational or pivoting axis extending crosswise relative to the translational movement and independently thereof so that all areas of the surface can be exposed to approximately the same amount of radiation.

The invention relates to an apparatus for curing a coating on an object, in particular a vehicle body, said coating consisting of a material which cures under electromagnetic radiation, in particular of a UV-curing paint or a heat-curing paint, having

a) at least one radiation emitter producing electromagnetic radiation;

b) a conveyor system, which conveys the object into the vicinity of the radiation emitter and away again therefrom.

Paints curing under UV light have hitherto mainly been used for painting sensitive objects, for example wood or plastics. In such fields the particularly significant advantage of these paints is that they may be polymerised at very low temperatures, so protecting the material of the objects from decomposition or outgassing. Curing of coating materials under UV light also has other advantages, however, which make this coating method of interest in relation also to application in other fields. These advantages include in particular the short curing time, which finds a direct reflection in shortening of the coating line, in particular in the case of coating methods which operate on a continuous basis. This is associated with enormous cost savings. As a result of the smaller dimensions, the device used to condition the gases located inside the apparatus may additionally be reduced in size, which likewise contributes to cost savings. Finally, the low operating temperature is also advantageous for objects which could actually bear higher curing temperatures, as it saves energy, in particular thermal energy.

Many of the objects which it would be desirable to coat with UV-curing materials, for example vehicle bodies, exhibit a very uneven, often three-dimensionally curved surface, such that it is difficult to introduce such objects into the radiation zone of a UV radiation emitter in such a way that all surface zones exhibit approximately the same distance from the UV radiation emitter and the UV radiation impinges at approximately a right angle on the particular surface zone of the object.

Known apparatuses of the above-mentioned type, such as have been used hitherto in the timber or printing industries, are unsuitable for this purpose, since the UV radiation emitter(s) was(were) arranged immovably therein and the objects were conveyed past the UV radiation emitter(s) by the conveyor system in more or less fixed orientation.

Recently, paints have additionally been developed which cure when exposed to heat in an inert gas atmosphere, forming very hard surfaces. The heat may be supplied in various ways, for instance by convection or by infrared radiation emitters.

In the latter case, similar problems arise to those described above with regard to the use of UV radiation emitters. In particular, therefore, all surface zones of the object to be painted should be conveyed past the infrared radiation emitter at approximately the same distance.

The object of the present invention is to develop an apparatus of the above-mentioned type in such a way that coatings may be cured with a good result even on complicatedly shaped, very uneven objects, in particular vehicle bodies.

This object is achieved according to the invention in that the conveyor system comprises:

c) at least one transport carriage, which may be displaced translationally on at least one running surface and comprises:
ca) a drive motor for the translational movement,
cb) a support frame, to which the object may be attached and which may be pivoted or swivelled independently of the translational movement about a pivot or swivel axis extending perpendicularly to the direction of the translational movement.

According to the invention, conveyor systems are used which are actually already in use for dip-coating of vehicle bodies or other objects. The present invention recognised that these conveyor systems are also suitable for moving complicatedly shaped objects in the radiation zone of radiation emitters in such a way, with a combination of swivelling or pivoting movements and translational movement, that all the surface zones of the object are exposed to a sufficient amount and intensity of radiation to cure the material. Complete curing only takes place on the one hand when the electromagnetic radiation impinges on the coating at an intensity above a threshold value and on the other hand when this intensity is also maintained over a given period. If the intensity is too low, a polymerisation reaction is not initiated or proceeds only slowly; if the irradiation period is too short, only incomplete curing is achieved.

The necessary radiant energy is also known in photometry as “irradiation” and is stated in J/cm². For common paints, the necessary irradiation amounts to several J/cm² in the case of UV light.

Slight “overexposure” of the coating beyond the necessary irradiation is not generally damaging. Preferably, however, the objects should be moved in such a way that the integrated radiant energy impinging on the coating per unit area is approximately constant over the entire surface of the object. This constant value should as far as possible lie only slightly above the value needed for curing, since strong overexposure may lead to embrittlement or indeed discoloration of the paint.

A particularly advantageous embodiment of the invention is characterised in that the transport carriage comprises at least one arm, to the outer end of which the support frame is attached in pivotable or swivellable manner and which may be pivoted or swivelled at its opposing, inner is end about a second pivot or swivel axis. Such a conveyor system is known from DE 201 05 676 U1, but is used therein for dipping vehicle bodies in treatment baths.

The transport carriage may conveniently be moved on two parallel running surfaces. In this way, the transport carriage is provided with the necessary stability without great structural complexity.

A particularly preferred embodiment of the invention is one in which the apparatus comprises a container open towards the conveying plane of the conveyor system, it being possible to introduce the object into the interior of said container by pivoting or swivelling the support frame and to expose said interior to electromagnetic radiation from at least one radiation emitter. This container ensures that no radiation and no gases can escape in a sideways direction, which needs to be avoided for the sake of the health of the operating personnel. In this embodiment of the invention, the transport carriages, which were designed to dip objects into and remove them from liquid containers, display their advantages particularly well.

The arrangement of the radiation emitters on or in the container may vary:

For instance, it is possible for at least one radiation emitter to be installed in a wall or the floor of the container. Where objects to be treated have three-dimensionally curved surfaces, a solution is preferred in which at least one radiation emitter is installed in the opposing side walls extending parallel to the translational movement of the objects and in at least one of the two end walls extending perpendicularly to the translational movement of the objects or in the floor of the container. Then all sides or surface zones of the object may be straightforwardly reached by the electromagnetic radiation.

Most universally useful, of course, is an embodiment of the invention in which a plurality of radiation emitters is arranged on all the walls and in the floor of the container.

In the above embodiments, in which the radiation emitters are arranged in the walls or in the floor of the container, the radiation emitters substantially constitute large-area radiation emitters.

However, radiation emitters may also advantageously be used which take the form of linear radiation emitters. In this case, an embodiment of the invention is particularly possible in which a plurality of radiation emitters are provided in a U-shaped arrangement with two substantially vertical legs and a substantially horizontal base. The object to be treated is then “threaded through” the interior formed by the U-shaped arrangement.

The approximately vertical legs of the U-shaped arrangement of radiation emitters may be adapted to the profile of the lateral contour of the object, such that, even in the event of these objects having a curved lateral contour, the desired perpendicular incidence of the electromagnetic radiation on the surface zones and the constant distance between surface zone and radiation emitter may be maintained.

To allow variable adaptation, the approximately vertical legs of the U-shaped arrangement of radiation emitters may be segmented, the segments being adjustable relative to one another.

The base of the U-shaped arrangement of radiation emitters may also be adapted to the profile of the contour of the objects. Once again, this adaptation may be variable if the base of the U-shaped arrangement of radiation emitters is segmented and the segments are adjustable relative to one another.

It is particularly preferred for a protective gas to be fed to the interior of the container. The protective gas primarily has the function of preventing the presence of oxygen in the radiation zone of the radiation emitters, since this oxygen could be converted into harmful ozone under the influence of the electromagnetic radiation, in particular in the case of UV light, and is additionally harmful in the polymerisation reaction.

The protective gas may be heavier than air, in particular it may be carbon dioxide. In this case, the container is open at the top. The container is filled with the heavy protective gas as with a liquid.

However, it is also possible for the protective gas to be lighter than air, in particular it may be helium. In this case, the container is constructed as a hood open at the bottom, in which the protective gas collects. The “floor” then becomes the ceiling of the container.

Irrespective of whether the container is open at the top or the bottom, the coated objects may be straight-forwardly introduced into and removed from the protective gas atmosphere inside the container by means of the transport carriage used according to the invention.

The protective gas is conveniently used at the same time as a cooling gas for the radiation emitters.

If a device is provided which directs protective gas towards the surface zone exposed to the radiation emitter, it is possible to ensure a particularly defined, oxygen-free atmosphere at the reaction location.

In particular in the case of objects comprising cavities, it is sensible to provide a device which blasts the object with a directed protective gas stream prior to entry into the radiation field of the radiation emitter or the protective gas atmosphere, in order to expel entrained air.

If a mobile reflector is associated with at least one of the radiation emitters on the side remote from the object, additional adaptation of the radiation direction to the profile of the surface of the object to be treated is possible.

The container may be provided with a reflective layer on its inner surfaces. In this way, lower power radiation emitters may be used.

In this case, it is particularly favourable for the reflective layer to consist of aluminium foil. This has a very good reflective capacity for electromagnetic radiation and is obtainable at a reasonable price.

The reflective action is enhanced in that the aluminium foil comprises a plurality of uneven areas, for example is creased. In these circumstances, reflection proceeds at a very wide range of angles, such that the interior of the container is filled very uniformly with electromagnetic radiation exhibiting the most varied propagation directions.

The apparatus according to the invention should comprise a booth housing, which prevents uncontrolled escape of gases and electromagnetic radiation. Both would be hazardous to the health of operating personnel.

An airlock may be provided for the transport carriage at each of the in- and outlet of the booth housing. These airlocks prevent relatively large quantities of air from the external atmosphere from entering the booth housing on introduction of the transport carriage into the booth housing or its removal therefrom, and furthermore protect personnel from electromagnetic radiation.

However, since the penetration of air, in particular of oxygen, into the interior of the booth housing cannot be completely eliminated even with airlocks, a device is conveniently provided for removing the oxygen from the atmosphere inside the booth housing. This device may comprise a catalyst for catalytic binding of the oxygen, a filter for absorption of the oxygen or indeed a filter for adsorption thereof.

If the coating material initially still contains a relatively large amount of solvent, as is the case for example with water-based paints, the device for removing the solvent from the coating material may comprise a preheating zone.

If, on the other hand, pulverulent materials are to processed, the device for gelling this pulverulent material may have a corresponding preheating zone.

In both preheating zones, the objects may be heated convectively, by IR or microwave radiation or indeed in some other manner.

A measuring station may be mounted upstream of the at least one radiation emitter in the conveying direction, said measuring station being used to detect the three-dimensional shape data of the object. These data may be used therein to guide the object as it moves past the radiation emitter(s).

The measuring station may comprise at least one optical scanner, by which the object may be scanned at least in one direction. The optical scanner may comprise an infrared light source.

Alternatively, the measuring station may also comprise a video camera and a device for digital imaging.

In one embodiment of the invention, the data obtained by the measuring station may be stored in a control device, which reads these data out again during subsequent movement of the object past the at least one radiation emitter and uses them to control the movement of the object. Measurement of the object may here take place at any desired location upstream of the irradiation location and at any desired time preceding the irradiation time.

Alternatively, the measuring station may be arranged in the immediate vicinity of the at least one radiation emitter and a control device may be provided, which uses the data obtained from the measuring station without a time delay directly to control the movement of the object.

This measuring station may for example contain a light barrier.

Under certain circumstances, it is also possible to dispense with measurement of the object if a control device is provided in which the spatial data associated with a specific type of object may be stored and read out therefrom if required.

If a plurality of radiation emitters are provided in irregular arrangement, better edge illumination is in particular achieved, which is known in car body technology as “wraparound”.

The electromagnetic radiation is preferably UV light or infrared radiation.

Exemplary embodiments of the invention are explained in more detail below with reference to the drawings, in which

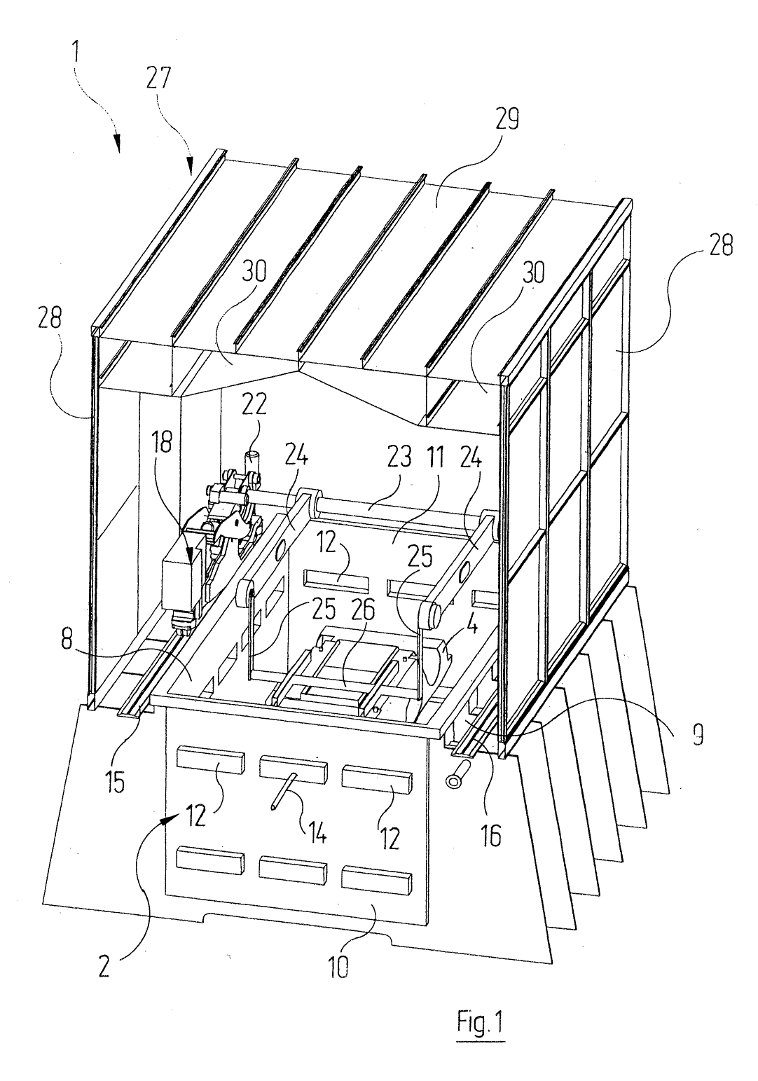

FIG. 1 is a perspective, partially opened-up view of an apparatus for curing a UV paint on vehicle bodies;

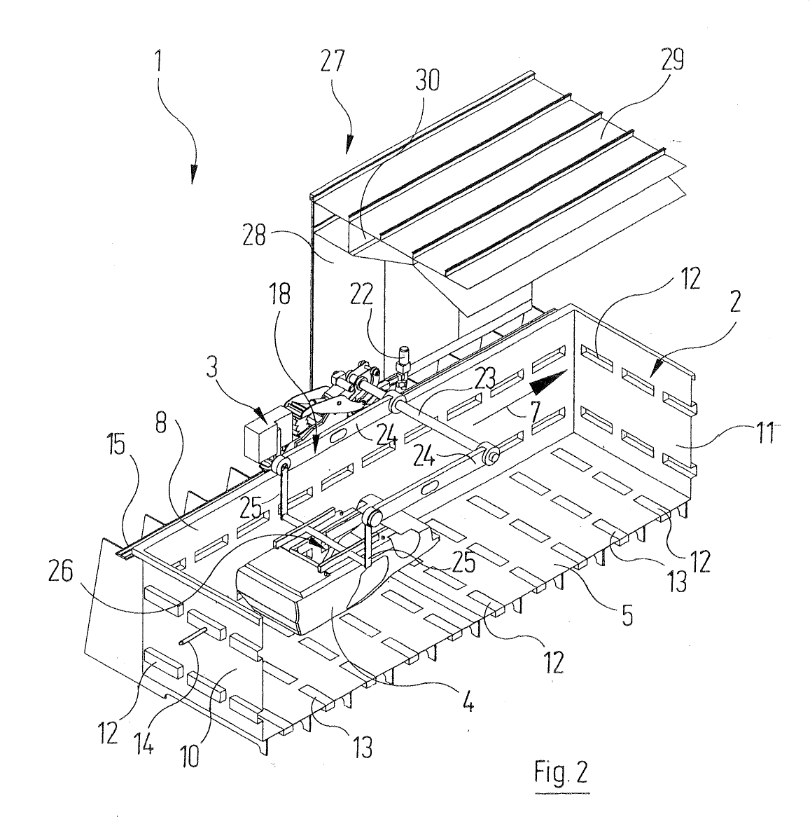

FIG. 2 is a view, similar to FIG. 1, but with the side wall of the container and booth housing of the apparatus removed;

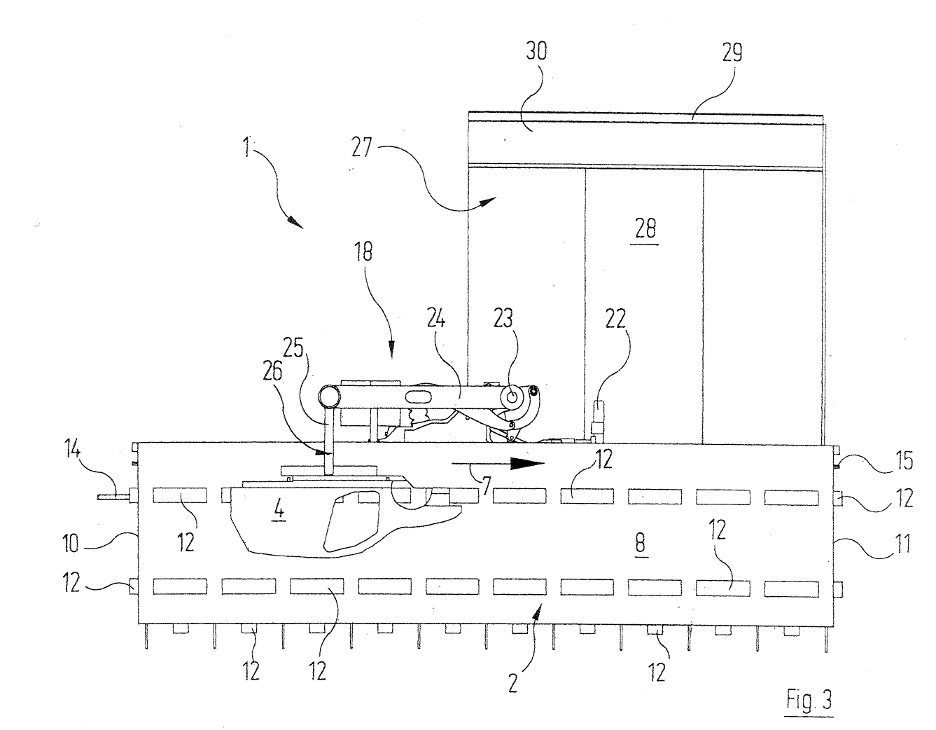

FIG. 3 shows a section through the apparatus of FIGS. 1 and 2 parallel to the direction of translational movement of the vehicle bodies;

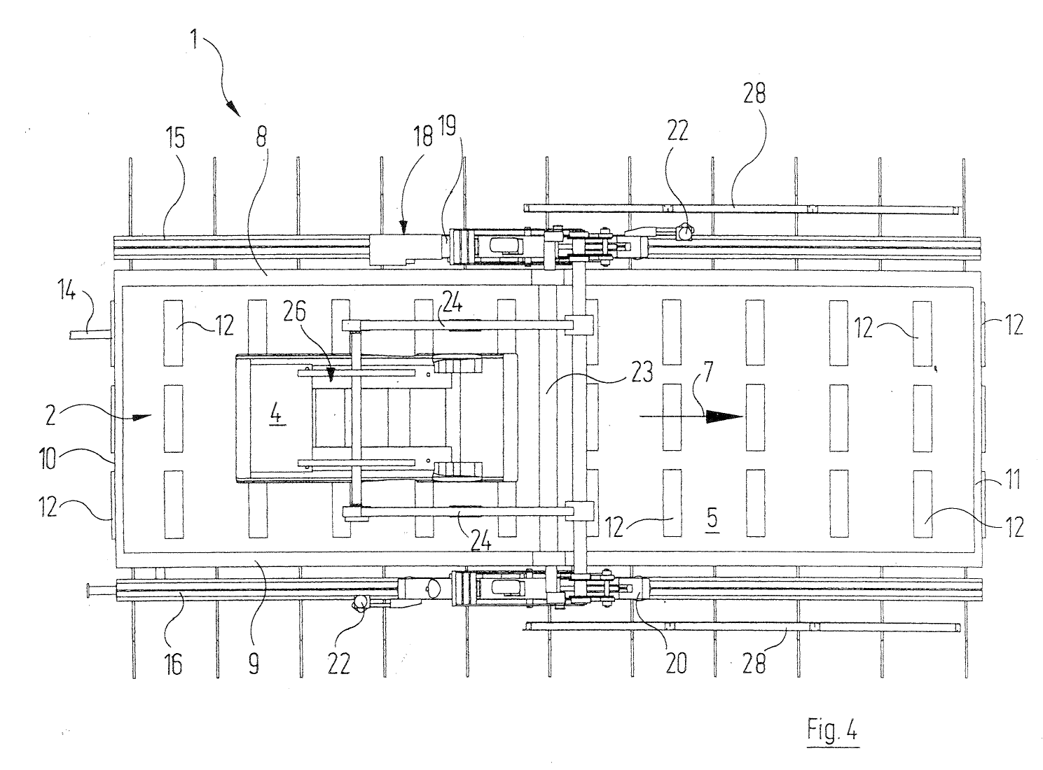

FIG. 4 is a plan view of the container and the conveyor system of the apparatus of FIGS. 1 to 3;

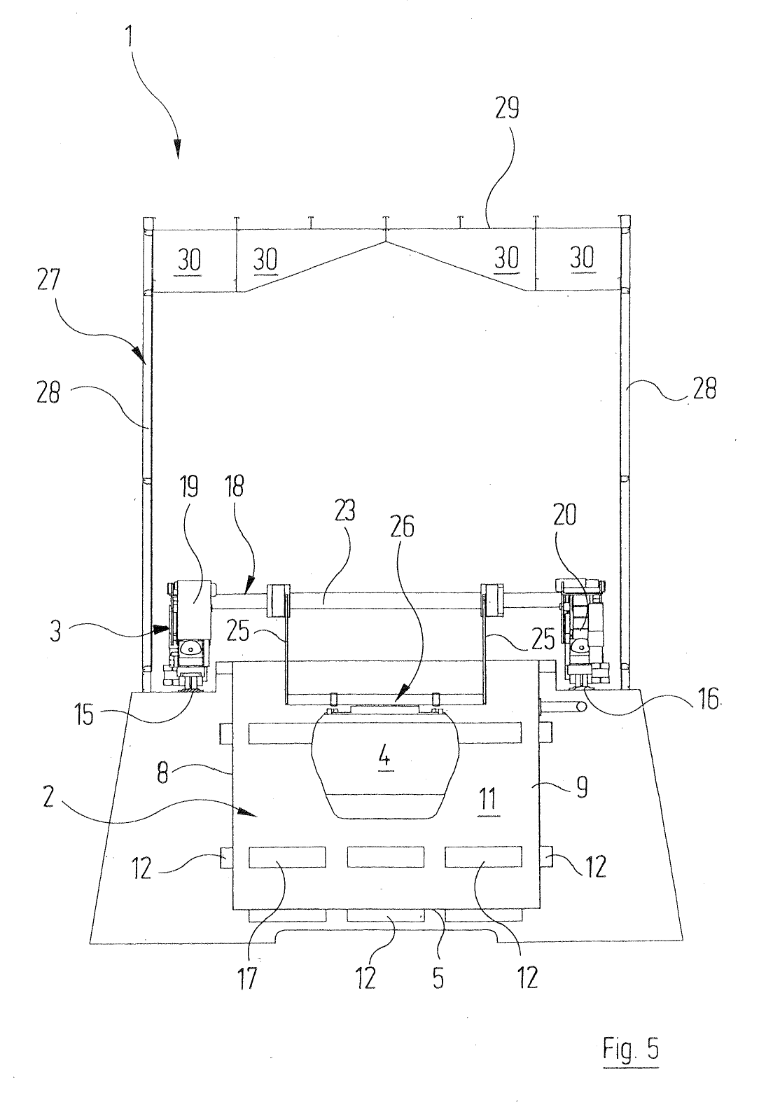

FIG. 5 shows a section through the apparatus of FIGS. 1 to 4 perpendicular to the direction of translational movement of the vehicle bodies;

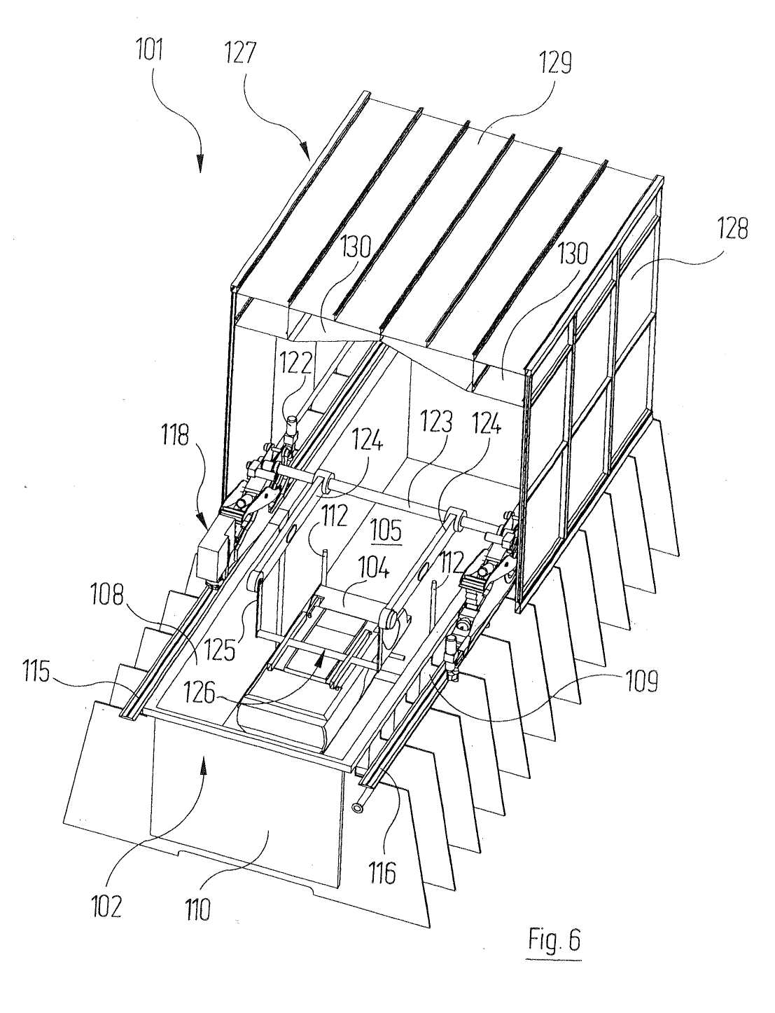

FIG. 6 is a perspective view, similar to FIG. 1, of a second exemplary embodiment of an apparatus for curing a UV paint on vehicle bodies;

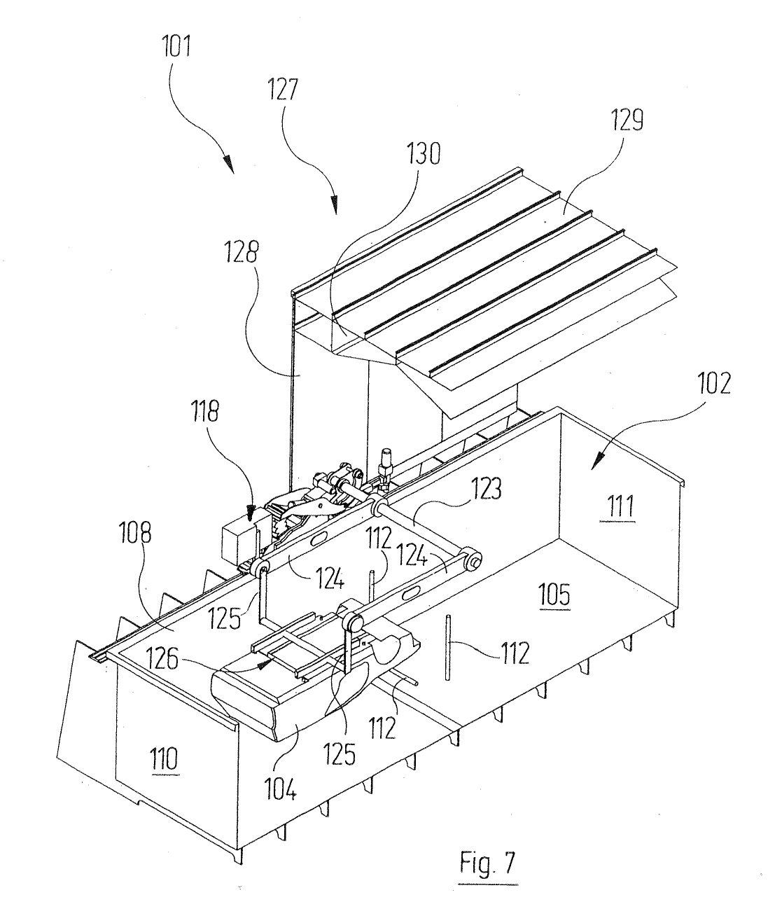

FIG. 7 is a perspective view of the second exemplary embodiment, similar to FIG. 2;

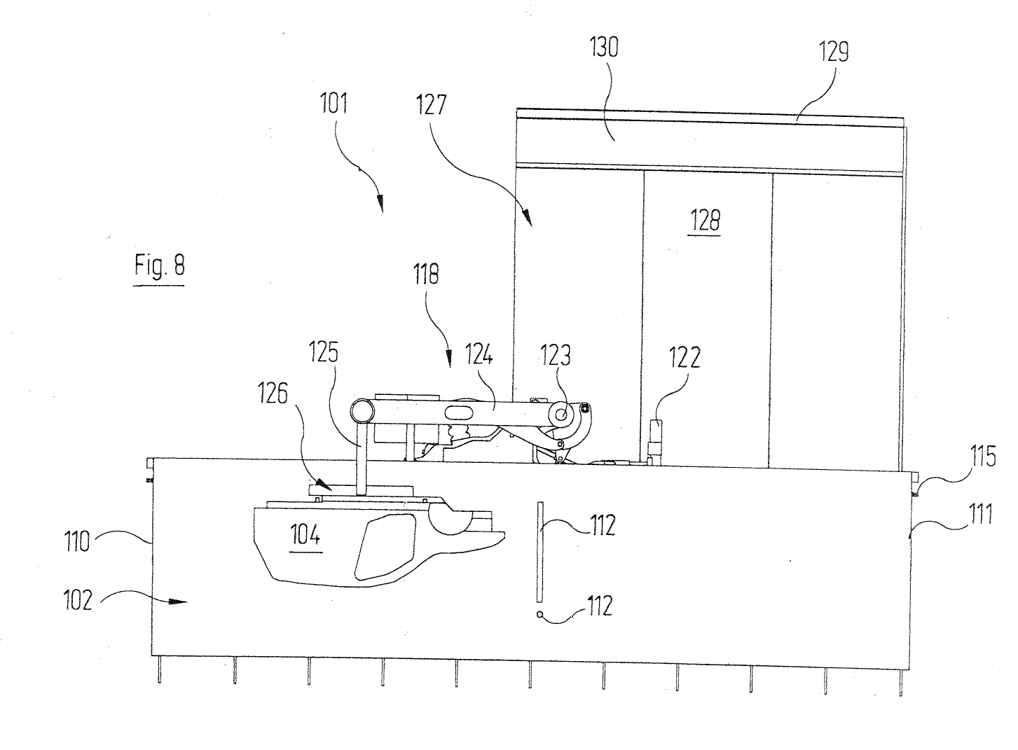

FIG. 8 shows a section through the apparatus of

FIGS. 6 and 7 parallel to the direction of translational movement of the vehicle bodies;

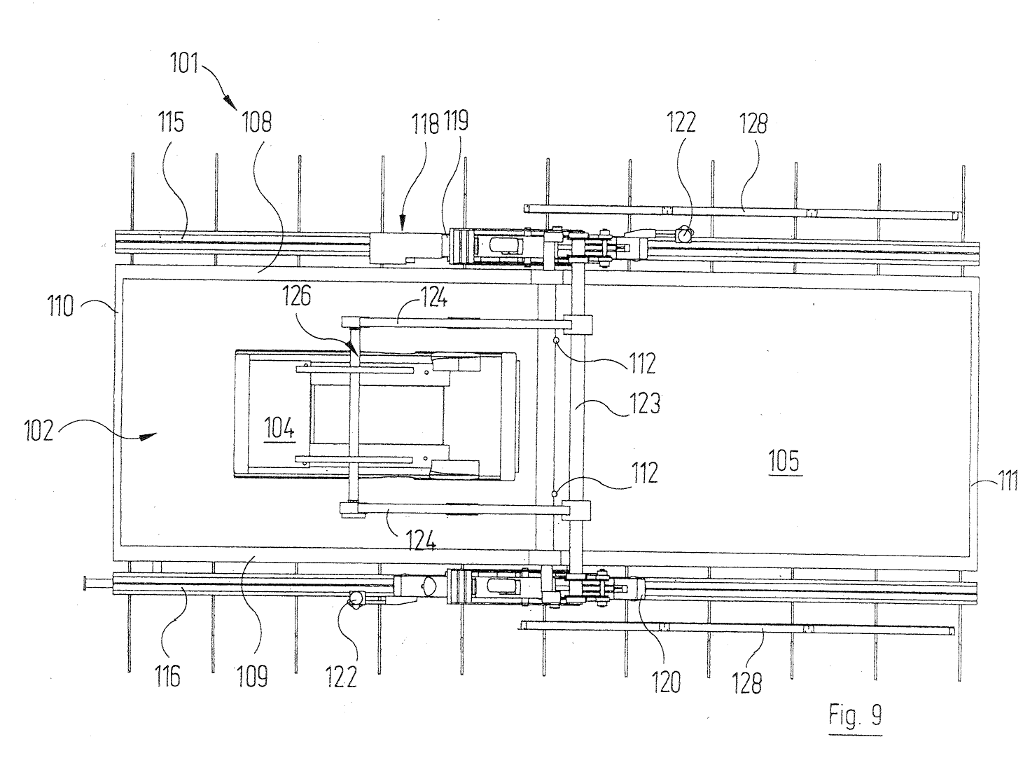

FIG. 9 is a plan view of the container and the conveyor system of the apparatus of FIGS. 6 to 8;

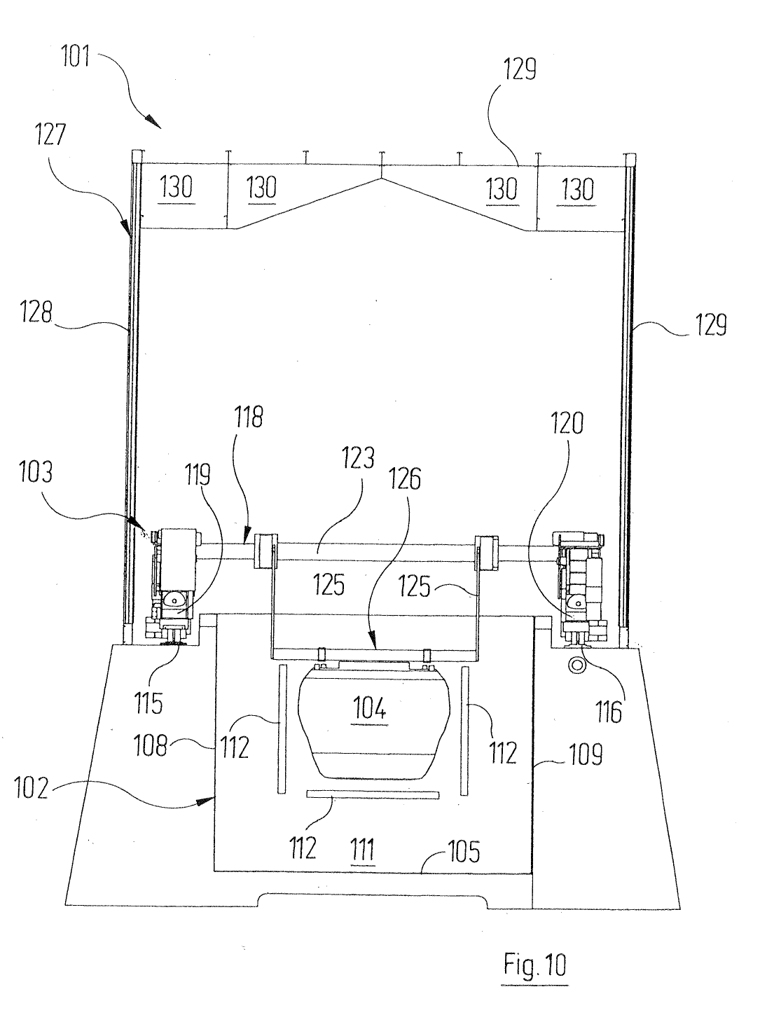

FIG. 10 shows a section through the apparatus of FIGS. 6 to 9 perpendicular to the conveying direction of the vehicle bodies;

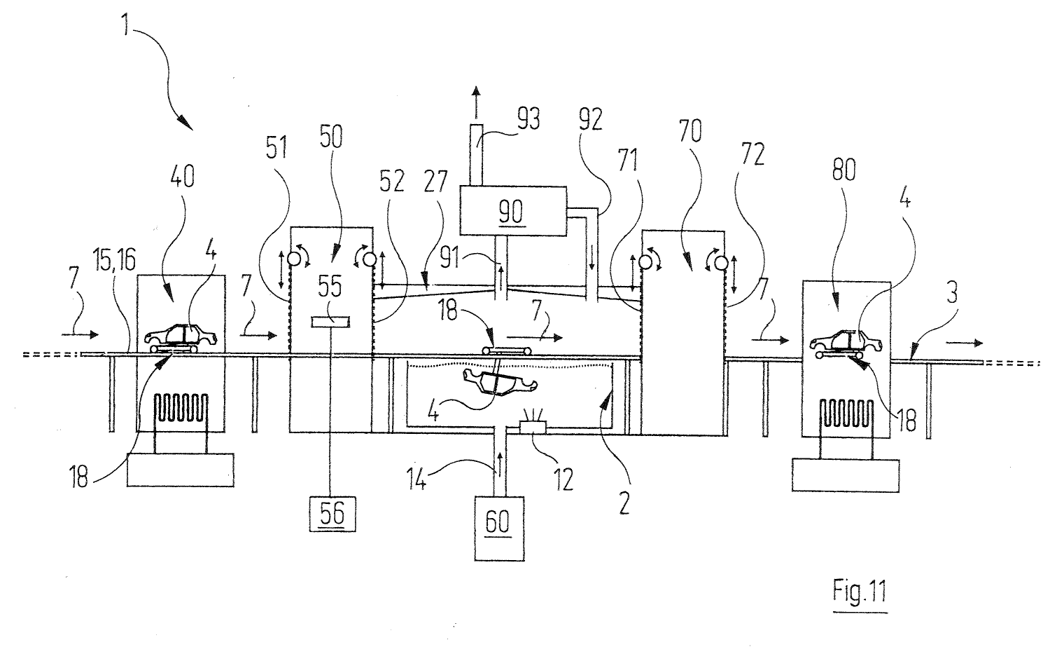

FIG. 11 is a schematic overall view of the apparatus of FIGS. 1 to 5 with various peripheral devices.

Reference will be made first of all to FIGS. 1 to 5. These show the core area of a first exemplary embodiment of an apparatus which serves to cure with UV light a UV paint applied to vehicle bodies in a preceding coating station.

The apparatus, labelled overall with reference numeral 1, comprises a container 2 open at the top, which resembles a paint tank known from dip coating vehicle bodies. A conveyor system 3, which is described in greater detail below, extends beyond the container 2 and is in a position to “dip” the vehicle bodies 4 it conveys into the container 2 and move them therein in a manner which is likewise described in greater detail below.

The substantially cuboid container 2 contains a plurality of UV radiation emitters 12 in its floor 5 and in the side walls 8 and 9 extending parallel to the conveying direction of the conveyor system 3, which is labelled by the arrow 7, and in the end walls 10 and 11 extending perpendicularly thereto. The light outlet faces of the radiation emitters 12 are directed towards the inside of the container 2 and covered by an IR filter, such that thermal radiation produced by the UV radiation emitters 12 cannot reach the interior of the container 2.

Gaseous carbon dioxide is supplied to each UV radiation emitter 12 via a line 14, of which only one is illustrated in the Figures so as not to overload them with detail. This carbon dioxide flows around the parts of the UV radiation emitters 12 which become hot when in operation and then flows out at the inside of the floor 5 and the walls 8, 9, 10, 11 of the container 2. In this way, the gaseous carbon dioxide, which is heavier than air, fills the interior of the container 2 from the bottom up. The quantity of gaseous carbon dioxide supplied via the lines 14 is in dynamic equilibrium with the quantity of carbon dioxide which escapes at the open top of the container 2 and is then drawn off from the apparatus 1 in a manner explained further below.

The conveyor system 3 is of similar construction to that described in the above-mentioned DE 201 05 676 U1, to which reference is made for further details. It comprises two running surfaces 15, 16, which extend on each side of the container 2 parallel to the conveying direction 7 and on which a plurality of transport carriages 18 may be moved. Each of these transport carriages 18 has two longitudinal beams 19, 20, on the underside of which wheels 21 are in each case mounted rotatably about a horizontal axis. In addition, the wheels 21 are rotatable about a vertical axis by means of a pivoted bolster, not shown in detail, such that the orientation of the wheels 21 relative to the respective longitudinal beams 19, 20 may be altered.

The wheels 21 roll on the above-mentioned running surfaces 15, 16 and are guided thereby by means of interlocking engagement, details of which may be found in DE 201 05 676 U1. The transport carriage 18 is moved in freely programmable manner along the running surfaces 15, 16 by means of a friction drive, which is likewise to be found in the above-stated publication and comprises a drive motor 22 on each longitudinal beam 19, 20, and may thus be accelerated, decelerated, moved at a constant speed or indeed stopped independently of all other transport carriages 18 in the same conveyor system 3.

The two longitudinal beams 19, 20 of the transport carriage 18 are connected together via a swivel shaft 23, which may be rotated by means of a drive motor, not shown in the drawings, independently of the translational movement of the transport carriage 18. Rigidly attached to the swivel shaft 23 are the first ends of two swivel arms 24, which each extend in the vicinity of a longitudinal beam 19, 20, parallel thereto and offset inwards somewhat.

Coupled to the opposing ends of the swivel arms 24 are two struts 25 of a support frame, labelled overall with reference numeral 26, to which the vehicle body 4 is then attached, optionally together with a skid carrying the vehicle body 4. The joint spindles, by means of which the swivel arms 24 are connected to the struts 25 of the support frame 26, are motor-driven in a manner not revealed by the drawings, such that the angle between the swivel arms 24 and the struts 25 of the support frame 26 may be modified independently of the swivelling of the swivel arms 24 about the swivel shaft 23 and independently of the translational movement of the transport carriage 18 in the conveying direction 7.

The top of the container 2 is covered by a booth housing 27, which comprises glass side walls 28 and a roof structure 29. It goes without saying that the glass from which the side walls 28 are made is impermeable to UV light.

The roof structure 29 is provided with various cavities 30 extending parallel to the conveying direction 7, by means of which cavities conditioned gas may be supplied to the interior of the booth housing 27 and gas, including the carbon dioxide and possibly ozone escaping from the container 2, may be drawn off in controlled manner from the interior of the booth housing 27.

Where they are not occupied by the outlet faces of the UV radiation emitters 12, the floor 5 and the walls 8, 9, 10, 11 of the container 2 are covered with a reflective aluminium foil, which has additionally been made uneven for example by creasing or by other irregular bumps.

The above-described apparatus 1 operates as follows:

During operation, the DV radiation emitters 12 are functional, such that the entire interior of the container 2 is filled with UV light, which is additionally reflected in the widest possible range of directions by the creased aluminium foil attached to the inner surfaces of the container walls 8 to 11 and the container floor 5, being evened out in this way. The UV radiation emitters 12 are cooled by the gaseous carbon dioxide supplied via the lines 14. The carbon dioxide gas, which is preheated only insignificantly in this manner, enters the container 2 in the above-described manner and fills it from the bottom up. The carbon dioxide exiting from the top of the container 2, which may be mixed to a slight extent with outgassing products from the paint curing on the vehicle body 4 and ozone, reaches the interior of the booth 27 and is extracted therefrom via one of the cavities 30 in the roof structure 29. Extraction may also take place directly at the top edge of the walls 8 to 11 of the container 2.

The vehicle bodies 4 are each conveyed individually by means of a transport carriage 18 from bottom left in FIG. 2 to the container 2. They are then introduced into the interior of the container 2 following a movement curve, which may be individually adapted by simultaneous translational movement of the carriage 18, swivelling movement of the swivel arms 24 and swivelling movement of the struts 25, and there immersed in the carbon dioxide gas located therein. This carbon dioxide gas serves as protective gas and prevents air and in particular the oxygen contained therein from entering the interior of the container 2 and there forming ozone. This air or the oxygen contained therein would also be harmful during the polymerisation reaction within the paint on the vehicle body 4. The carbon dioxide gas, on the other hand, encourages the stated polymerisation reaction, which may take place in a very short time under the influence of the UV light emitted by the UV radiation emitters 12.

The vehicle body 4 clearly comprises highly curved surfaces in all three spatial directions. To ensure that all surface zones are exposed to approximately the same UV irradiation during passage through the apparatus, the vehicle body 4 is swivelled appropriately by means of the swivel arms 24 and the support frame 26. This may take place while translational movement of the transport carriage 18 is at a standstill or during translational movement both in the direction of arrow 7 and in the opposite direction.

If UV paint is to be cured which has been applied to the inner surfaces of the vehicle body 4 and is not accessible to the UV radiation emitters 12 from outside, an additional UV radiation emitter 12 may be used which is located on a movable arm capable of being introduced into the inside of the vehicle body 4.

Once the polymerisation process is complete, the vehicle body 4 is lifted out of the container 2 in the vicinity of the end wall 11 to the rear of the container 2 in the direction of movement 7 following a correspondingly adapted movement curve, as described in DE 201 05 676 U1.

FIGS. 6 to 10 show a second exemplary embodiment of an apparatus 101, with which the UV paint applied to a vehicle body 104 may be cured through exposure to UV light. This apparatus 101 greatly resembles the apparatus 1 of FIGS. 1 to 5; corresponding parts are therefore labelled with the same reference numerals plus 100.

The apparatus 101 contains a container 102 open at the top, a conveyor system 103 with a plurality of transport carriages 118 and a booth housing 127, which covers the container 102. To this extent, the situation is identical for the two exemplary embodiments of the apparatus 1 and 101 respectively.

However, unlike in the exemplary embodiment of FIGS. 1 to 5, there are no UV radiation emitters in the floor 105 and in the side walls 108 to 111 of the container 102. Instead, a U-shaped arrangement of UV radiation emitters 112 is provided approximately in the centre of the container 102, when viewed in the conveying direction 107. The base of this “U” consists of at least one “linear” UV radiation emitter 112 extending approximately horizontally and perpendicularly to the conveying direction 107; the two legs of the “U” consist in similar manner in each case of at least one approximately vertically extending “linear” UV radiation emitter 112.

The container 102 is somewhat longer than the container 2 of the exemplary embodiment of FIGS. 1 to 5. The interior of the container 102 is again filled with gaseous carbon dioxide, which may be supplied as cooling gas for the UV radiation emitters 112 but also at other locations.

The mode of operation of the exemplary embodiment illustrated in FIGS. 6 to 9 is as follows:

The vehicle bodies 104 coated with UV paint are moved by means of the transport carriage 118 from bottom left in FIG. 6 over the container 102 and then introduced into is the container 2 in the vicinity of the end wall 110, at the front in the conveying direction 107, following an appropriately adapted movement curve. Then the transport carriage 18 moves in the direction of arrows 107, wherein the vehicle body 104 is conveyed through between the two vertical legs of the U-shaped arrangement of UV radiation emitters 112 and over the base of said U. By swivelling the swivel arms 124 and the struts 125 of the support frame 126 appropriately, it is ensured that the surfaces located in the radiation zone of the horizontally extending UV radiation emitter 112 are at approximately the same distance from said UV radiation emitter 112 as they travel past and that the UV radiation emitted by this UV radiation emitter 112 is directed approximately at a right angle onto the surface zone in question, so ensuring that the desired approximately constant irradiation of all surface zones is ensured. If required, the translational movement of the transport carriage 118 may also be interrupted or reversed, such that individual surface zones are irradiated for longer than others.

After passage of the vehicle body 104 through the U-shaped arrangement of radiation emitters 112, the polymerisation reaction is substantially finished.

FIG. 11 is a schematic representation of the entire apparatus 1 described above with reference to FIGS. 1 to 5 with various peripheral devices 40, 50, 60, 70, 80 and 90. It also shows the conveyor system 3 with the individual transport carriages 18, on which the vehicle bodies 4 are moved translationally in the direction of arrows 7. This movement may proceed discontinuously, rearward movements also not being ruled out.

The transport carriages 18 pass first of all through a preheating station 40, which is heated with hot air in the exemplary embodiment shown. Alternatively, heating may be effected by IR radiation emitters or microwaves. The preheating station 40 may perform different functions depending on the type of coating material: if said material comprises solvent-based substances, for example is a water-based paint, the solvents are removed as far as possible in this station. If the material is a pulverulent material, the preheating station 40 serves to gel the powder and in this way to prepare it for the polymerisation reaction.

The transport carriages 18 with the vehicle bodies 4 then arrive at an inlet airlock 50, which is arranged upstream of the above described apparatus part in which irradiation with UV light takes place. The inlet airlock 50 is a double airlock with two movable gates 51 and 52.

The vehicle bodies 4 are initially moved into the airlock 50 when the gate 51 is open and the gate 52 is closed. Inside the airlock 50 there is an optical scanning device 55, with which the contour of the vehicle body 4 is scanned. The three-dimensional shape data thus obtained are fed to a control means 56 and initially stored therein.

Then the gate 51 is closed, the gate 52 is opened and the vehicle body 4 is introduced further into the interior of the booth housing 27. There the vehicle body 4, as described above, is introduced by swivelling of the arms 24 and of the support frame 26 into the container 2, which is filled with carbon dioxide gas from a carbon dioxide supply source 60. The vehicle body 4 moves in the container 2 past a plurality of UV radiation emitters 12, of which only one is shown in FIG. 11. The movement is controlled by the above-mentioned control means in accordance with the data obtained by the scanning device 55.

Instead of the scanning device 55, movement of the vehicle body 4 in the container 2 may also be controlled in accordance with body data stored in the control means 56. All that is then needed is a reader, which recognises the type of vehicle body 4 which is entering the container 2 at any one time and retrieves the three-dimensional shape data assigned thereto. The scanning device 55 may in this case additionally be used as a monitoring means.

The vehicle body 4 leaves the container 2 once again through swivelling of the arms 24 and of the support frame 26 and then arrives at a first movable gate 71 of an outlet airlock 70, whose second movable gate 72 is closed at this point. The transport carriage 18 travels with the vehicle body 4 through the open gate 71 into the interior of the outlet airlock 70. The inner movable gate 71 is then closed and the outer movable gate 72 is opened.

The vehicle body 4 travelling out of the outlet airlock 70 arrives in a postheating zone 80, in which the coating on the vehicle body 4 is held at an elevated temperature for a certain time and so stabilised. Then the transport carriage 18 with the vehicle body 4 leaves the apparatus 1. At a suitable location, the vehicle bodies 4 are removed from the transport carriages 18 and taken away for further use, while the transport carriages 18 are returned along a path which is not illustrated to the location at which they are reloaded with freshly coated vehicle bodies 4 and again introduced from the left into the apparatus 1 illustrated in FIG. 11.

As well as protecting the operating personnel from UV light, the airlocks 50 and 70 serve as far as possible to prevent the penetration of air into the interior of the booth housing 27, since the oxygen contained in the air would be converted into harmful ozone by the UV radiation present in the interior of the booth housing 27. However, the airlocks 50 and 70 cannot completely prevent air and thus oxygen from getting in. For this reason, a device 90 is provided which serves in removing introduced oxygen. To this end, gas is removed constantly from the interior of the booth housing 27 via a line 91 and for example passed over a catalyst in the device 90, which removes the oxygen catalytically. Part of this gas is returned to the interior of the booth housing 27 via the line 92, while another part is released into the external atmosphere via a line 93.

Instead of a catalyst, the device 90 may contain an oxygen-adsorbing or oxygen-absorbing filter.

In an exemplary embodiment which is not illustrated in the drawings, the measuring station for determining the spatial data comprises a video camera with a digital imaging device.

The components designated above as “radiation emitters” may be composed of a plurality of individual linear or approximately punctiform light sources.

The above exemplary embodiments are used for curing paints using UV light. However, they may also be used with paints which cure on exposure to heat, in particular in an inert gas atmosphere, i.e. for example in a CO₂ or nitrogen atmosphere. Substantially all that is then required is to replace the described UV radiation emitters with IR radiation emitters. Other structural adaptations associated with the change of electromagnetic radiation are known to the person skilled in the art and do not need to be explained here in any greater detail.

1.-41. (canceled)

42. A method of curing a coating on an object, in particular on a vehicle body, said coating consisting of a material which cures under electromagnetic radiation, in particular of a UV-curing paint or a heat curing paint, said method comprising the steps of:
a) providing an apparatus having at least one radiation emitter producing electromagnetic radiation in a radiation zone and a conveyer system said conveyer system comprising:
at least one transport carriage which is displacable translationally on at least one running surface and comprises:
a drive motor for the translational movement;
a support frame to which the object is attachable and is configured to pivot about an axis extending perpendicularly to the direction of the translational movement;
b) moving the object through the radiation zone of the at least one radiation emitter by pivoting the support frame and providing translational movement of the transport carriage such that that all surface zones of the object are exposed to a sufficient amount and intensity of radiation to cure a material on the surface zones of the object.

43. The method of claim 42 wherein the transport carriage comprises at least one arm having an outer end which is pivotably attached to the support frame and configured to pivot the support frame about the first axis and an opposing inner end configured to pivot about a second axis.

44. The method of claim 43 wherein the transport carriage is movable on two parallel running surfaces.

45. The method of claim 42 wherein the transport carriage is movable on two parallel running surfaces.
